(19) United States
(12) Patent Application Publication
(10) Pub. No.: US 2010/0225593 A1
(43) Pub. Date: Sep. 9, 2010

(54) Shelf Display Device

(76) Inventor: Marco Scibora, St. Paul, MN (US)

Correspondence Address: MERCHANT & GOULD PC, P.O. BOX 2903, MINNEAPOLIS, MN, 55402-0903, US

(21) Appl. No.: 12/716,738

(22) Filed: Mar. 3, 2010

Related U.S. Application Data
(60) Provisional application No. 61/157,051, filed on Mar. 3, 2009.

(51) Int. Cl. G06F 3/02

(52) U.S. Cl. 345/172; 345/168

(57) ABSTRACT

A display device configured to be mounted on a shelf includes a strip member sized to be mounted at a front end of the shelf, the strip member defining a front display area and a hollow interior, and a printed circuit board positioned within the hollow interior of the strip member. A button membrane is coupled to the front display area of the strip member, the button membrane defining a plurality of buttons, each of the buttons corresponding to a product located on the shelf behind the respective button, and each button being electrically coupled to the printed circuit board. A speaker is coupled to the printed circuit board, and the display device delivers an audio advertisement based on a selection by a user of one of the buttons.

### RELATED APPLICATION

This application claims the benefit of U.S. Patent Application Ser. No. 61/157,051 filed on Mar. 3, 2009, the entirety of which is hereby incorporated by reference.

### BACKGROUND

Traditional in-store digital audio and/or video delivery systems use wired and/or wireless LAN-based technology with fixed placement of Multimedia devices (kiosks, TVs, computer-based screens, etc.). Wireless technology in a commercial application does not necessarily equate to free mobility. The in-store LAN is necessary to either update each Multimedia device with fresh content on its local storage media (hard drive, flash card, etc.) or stream digital content from the local server or remote Internet server. Such systems are typically inflexible in design and implementation.

### SUMMARY

According to one aspect, a display device is configured to be mounted on a shelf. The display device includes a strip member sized to be mounted at a front end of the shelf, the strip member defining a front display area and a hollow interior, a printed circuit board positioned within the hollow interior of the strip member, a button membrane coupled to the front display area of the strip member, the button membrane defining a plurality of buttons, each of the buttons corresponding to a product located on the shelf behind the respective button, and each button being electrically coupled to the printed circuit board, and at least one speaker coupled to the printed circuit board. The display device delivers an audio advertisement based on a selection by a user of one of the buttons.

According to another aspect, a display device is configured to be mounted on a shelf. The display device includes a strip member sized to be mounted at a front end of the shelf, the strip member defining a front display area and a hollow interior, a printed circuit board positioned within the hollow interior of the strip member, a button membrane coupled to the front display area of the strip member, the button membrane defining a plurality of buttons, each of the buttons corresponding to a product located on the shelf behind the respective button, and each button being electrically coupled to the printed circuit board, an interchangeable paper-artwork strip coupled to the front display area in front of the button membrane, a plastic cover positioned in front of the paper-artwork strip, at least one speaker coupled to the printed circuit board, and a battery coupled to the device to power the device. Adjacent buttons on the button membrane are spaced to correspond to products located on the shelf behind the device, and the display device delivers an audio advertisement based on a selection by a user of one of the buttons.

### DESCRIPTION OF THE FIGURES

FIG. 1 shows an example shelf display device.

FIG. 2 shows an exploded view of the shelf display device of FIG. 1.

FIG. 3 shows another exploded view of the shelf display device of FIG. 1.

FIG. 4 shows a portion of the shelf display device of FIG. 1 in use with example products.

### DETAILED DESCRIPTION

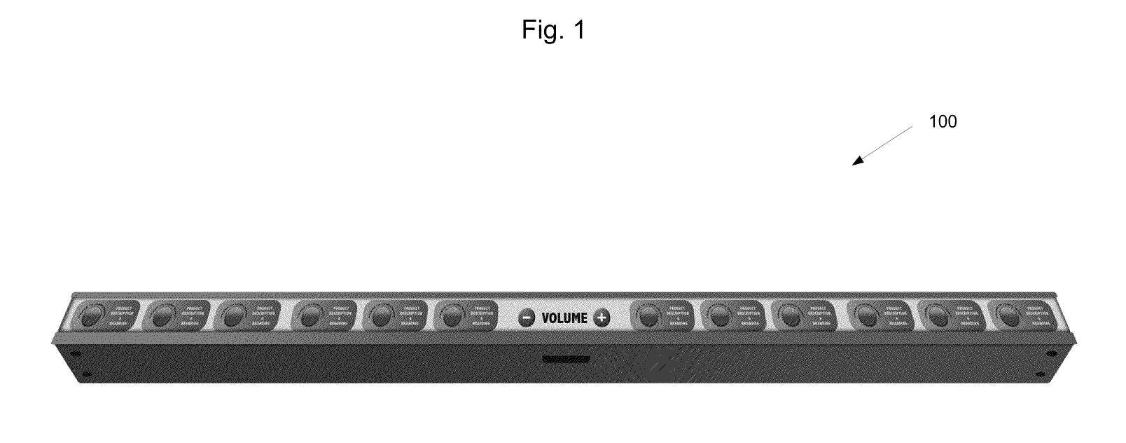

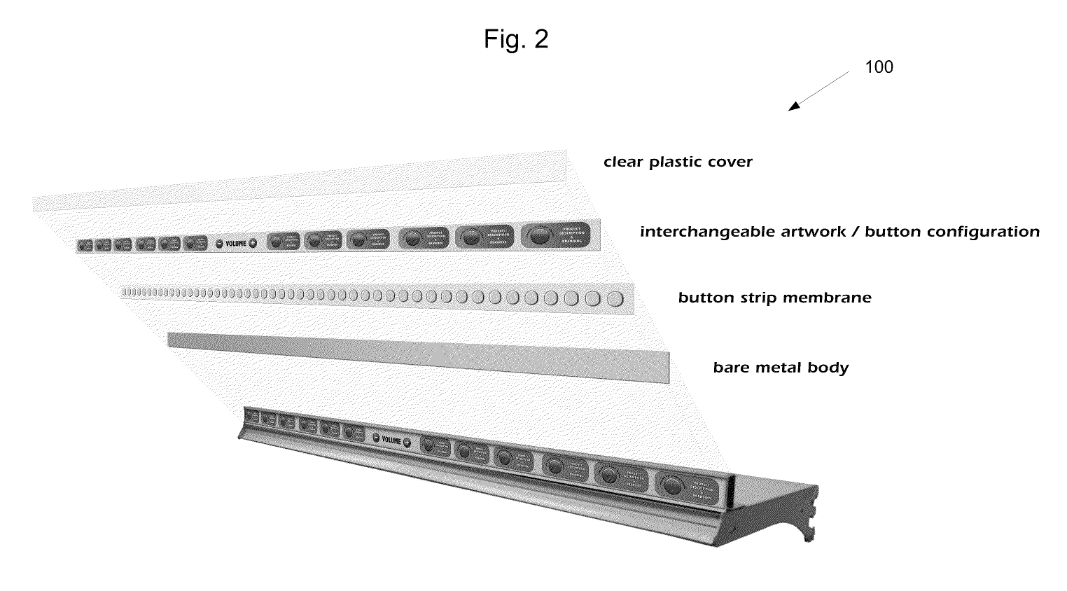

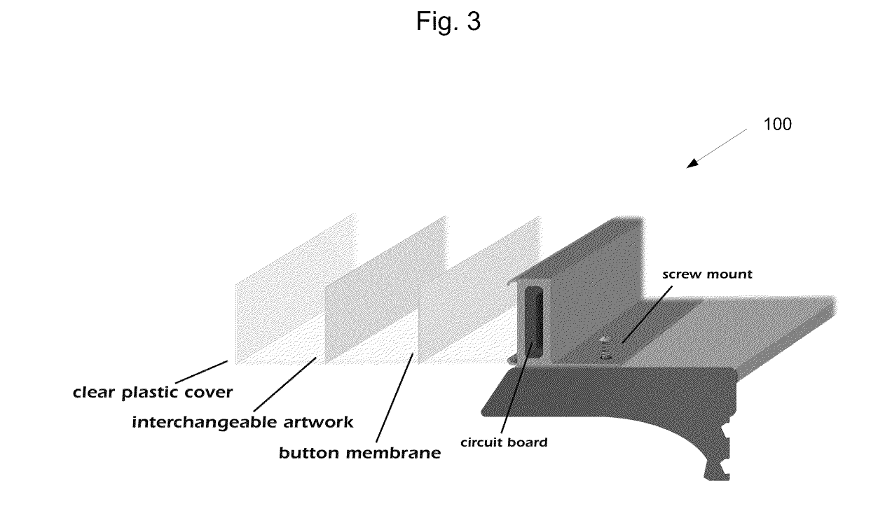

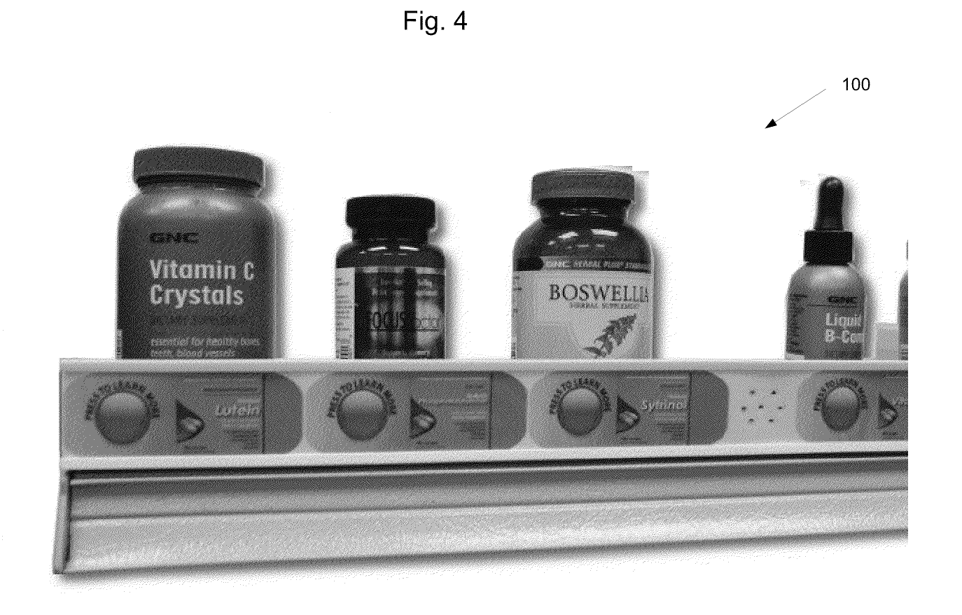

This disclosure relates to a design and implementation of a digital audio and/or video technology implemented in the form of a shelf display device 100 shown in FIGS. 1-4. In example embodiments, the display device 100 is used to deliver audio or multimedia advertisements in a retail environment.

In example embodiments, the shelf display device includes an “all-in-one” variable length narrow tube-like strip outfitted with a circuit board, small speakers, a multiplicity of interactive buttons, C-channel strip used for placement of an interchangeable paper-artwork strip with optional clear plastic protective shield. The shelf display device is designed to allow for mobility (placement) within physical retail (operator) floor space strategically placed at the very front edge of any retail product display shelf (although other placement options are possible).

This device is specifically designed to disseminate a multiplicity of digitally pre-recorded audio and/or Video (graphics, full motion video, animation, etc.) content available to retail shopper (user) by simply touching/pushing one of multiple choice buttons (trigger button) located on the front plate of the Shelf display device. Its unique design allows for flexible alignment of each designated trigger button with designated product displayed on the shelf.

For example, if IST is to provide information or promote six unique products, it will be possible to pre-select and than configure six out of multiplicity of buttons to properly lineup designated button(s) with each product being promoted. Doing so provides an intuitive means for the user to learn about the product of interest by pressing a trigger button located underneath the product.

Depending on configuration, each shelf display device can be either AC or battery powered. In examples, the internal digital audio and/or video content is stored on an integrated, non-volatile, fixed or removable media, such as Flash Card, SD Card, NAND, etc. Changeover of the digital content can be accomplished either by a manual function performed by a person right at the shelf display device or through the use of internal wired or wireless LAN and WAN. This device, when configured as a standalone application, minimizes the need for wired and/or wireless connectivity of each device to central control unit (server), as well as AC power.

This optional standalone device provides the operator with flexibility in placement of the shelf display device. It provides an inexpensive means for interactive dissemination of pre-recorded digital audio and/or video information on an as needed and where needed basis, including digital content refresh (with custom button assignment) for each upcoming promotional event. In example embodiments, the main components of the shelf display device can include:
1) Audio Only, Flash-Card-Based, Battery-Operated Shelf Display Device is equipped with:
   a. Device enclosure: 24″, 36″ or 48″ long, 1.5″ high and 0.6″ deep (other lengths available);
   b. Circuit board (audio, processor, button configuration chip, memory, etc.);
   c. Multi-button Membrane Strip: 48″=46 buttons, 36″=32 buttons and 24″=22 buttons;
   d. Speaker(s);
   e. 2 visual attention-trigger LED flashing lights;
   f. Designated to buttons for audio volume controls (up & down);
   g. Button Configuration—Interchangeable Artwork;
   h. Clear protective plastic cover;
   i. Each Multimedia devices has its own unique name (ID);
   j. Flash Card socket with slot to insert & remove flash card;
   k. USB plug-in;
   l. Wireless LAN with internal antenna (only for LAN based operation);
   m. Software:
      i. button configuration;
      ii. network controls (only for LAN based operation);
      iii. unique name (ID) (only for LAN based operation); and
      iv. Usage statistics gathering—e.g., time and frequency of actuation of each button of the button membrane.
2) Audio/Video, Flash-Card-Based, Battery-Operated Shelf Display Device is equipped with:
   a. Device enclosure 24″, 36″ or 48″ long, 1.5″ high and 0.6″ deep (other lengths available);
   b. Multi-button Membrane Strip: 48″=40 buttons, 36″=28 buttons and 24″=28 buttons;
   c. Speakers (1 or 2);
   d. 2 attention trigger LED flashing lights;
   e. 3.5″ video screen device based on embedded architecture mounted in the center of the device enclosure;
   f. Audio volume controls buttons (up & down) embedded on the 3.5″ video screen device;
   g. Capacitive or resistive Touch Screen;
   h. Each Multimedia device has its own unique name (ID);
   i. Flash Card socket with slot to insert & remove flash card;
   j. USB plug-in;
   k. Wireless LAN with internal antenna (only for LAN based operation);
   l. Software:
      i. button configuration;
      ii. network controls (only for LAN based operation);
      iii. unique name (ID) (required for LAN based operation and thumb drive updating); and
      iv. Usage statistics gathering.

The shelf display device includes a multi-button function and the software controlled flexible assignment of multiplicity of buttons to provide an intuitive lineup of each designated button with each designated promoted product. The operator can efficiently control the placement of the shelf display devices on the edge of designated shelf and easily manage the process for the desired content to be used on an as needed basis. The device accommodates frequent and on-demand in-store promotional events set-up throughout the store.

The device's enclosure can be metal, cut plastic or injection molding plastic formed in a tube-like fashion to accommodate fixed placement of circuit board, flash card, speakers and multi-button strip membrane. It is also designed to allow for updating the content using a thumb drive (USB) or interchangeability of flash card(s) and promotion specific artwork identifying to the user which button is functional.

Having a multiplicity of membrane buttons (one example has 48 buttons, although other arrangements can be used) allows for easy button configuration and placement. Activating or deactivating designated buttons is configured via small database placed on the non-volatile media (flash card). Since there are 46 buttons, about 1″ apart, all 46 buttons can be functional, whereby each button can have its unique slaved, pre-recorded digital audio and/or video content. However, if the promotional planogram calls for less products, such as a twelve unique product promotion (separated 6″ on the center), an operator can easily activate only 12 buttons, each 6″ apart. As such, each of the six buttons will closely lineup with each selected product making the remaining 28 buttons non-functional. With each content changeover and/or new planogram, the digital content can be matched with predefined buttons to accommodate proper spacing.

Since there is total of 46 buttons (there could be more or less) per each device and only predefined number of buttons will be designated to be functional per each promotional campaign, one needs to provide visual indication to the user which of the buttons are operative. As such, another aspect is the interchangeable artwork strip designed to be placed (slid) on top of the 46-button membrane. Inserting artwork strip depicting dedicated button locations that is lined up with each designated product will provide user with an intuitive means to activate the playback of the pre-recorded content lined up with the product of interest. In summary, the number of active buttons will be the same as there is number of product. Each button's digital content will be slaved to its related product.

Prior to launching a product campaign, each device is configured to match specific campaign plans; number of products, product (button) separation (inches on center) and proper content for each product. Each device can be pre-loaded with pre-defined digital content coordinated with scheduled promotion in the specific department for specific product(s) or service. As noted below, the device can be provided with a unique ID number that assists proper content uploading per each unit and usage retrieval information.

A centrally-managed operation can be effective to provide a consistent execution of the product campaign. A central operator can provide proper information related to a desired number of promotional events; identify the store's department, number of products, participating manufacturer(s), and the scope of the promotion, digital content relative to the event with description of placement of the device.

With this information, the content manager can configure each shelf display device with proper content for desired promotional event and button location assignment. Once the content creation and button configuration is completed and artwork strip is printed, the artwork strip and newly configured removable media (flash card, etc.) will be ready for shipment to each participating retail outlet. An alternative means of updating can be accomplished using a USB thumb drive and updating new content and button assignment on the fixed storage media of the device. Since each device has its own unique ID number, a single thumb drive can be used to update multiple devices (within a single store). Specific content is properly coded to match the unique ID of the device to avoid duplication single content on multiple devices. As such, when thumb drive is inserted into device's USB port, the software on the thumb drive will look for the unique ID numbers and automatically updates the device with proper content. In addition, the usage statistics of the previous campaign will be transferred from the device onto the thumb drive for future analysis. The WAN, LAN-based configuration allows for direct digital update of the content to each device, eliminating physical shipping and updating.

After the package containing the removable media and the artwork strip is received, the operator either replaces the old removable media with the new one or updates the device using a thumb drive and replaces the old artwork strip with the new one.

The old artwork strip can be discarded and the old removable media or the thumb drive is sent back to the central operator. Once received, the central operator can extract the usage statics relative to the previous campaign for analysis, which is stored on the old removable media.

Network-based configuration can be managed remotely by central operator at the end of each campaign and before new one is scheduled.

What is claimed is:

1. A display device configured to be mounted on a shelf, the display device comprising:
a strip member sized to be mounted at a front end of the shelf, the strip member defining a front display area and a hollow interior;
a printed circuit board positioned within the hollow interior of the strip member;
a button membrane coupled to the front display area of the strip member, the button membrane defining a plurality of buttons, each of the buttons corresponding to a product located on the shelf behind the respective button, and each button being electrically coupled to the printed circuit board; and
at least one speaker coupled to the printed circuit board;
wherein the display device delivers an audio advertisement based on a selection by a user of one of the buttons.

2. The device of claim 1, wherein the device is configured to be uncoupled from the shelf and moved to a new shelf.

3. The device of claim 1, further comprising a battery coupled to the device to power the device.

4. The device of claim 1, wherein adjacent buttons on the button membrane are spaced to correspond to products located on the shelf behind the device.

5. The device of claim 1, further comprising an interchangeable paper-artwork strip coupled to the front display area in front of the button membrane.

6. The device of claim 1, further comprising a plastic cover positioned in front of the paper-artwork strip.

7. The device of claim 1, further comprising a memory coupled to the printed circuit board.

8. The device of claim 7, wherein the memory is removable memory.

9. The device of claim 7, wherein the memory is non-volatile memory.

10. The device of claim 1, wherein a functionality of each of the buttons of the button membrane is programmable.

11. The device of claim 1, wherein the device is configured to gather usage statistics.

12. The device of claim 11, wherein the usage statistics include time and frequency of actuation of each button of the button membrane.

13. The device of claim 1, wherein the device includes an identification number that uniquely identifies the device.

14. A display device configured to be mounted on a shelf, the display device comprising:
a strip member sized to be mounted at a front end of the shelf, the strip member defining a front display area and a hollow interior;
a printed circuit board positioned within the hollow interior of the strip member;
a button membrane coupled to the front display area of the strip member, the button membrane defining a plurality of buttons, each of the buttons corresponding to a product located on the shelf behind the respective button, and each button being electrically coupled to the printed circuit board;
an interchangeable paper-artwork strip coupled to the front display area in front of the button membrane;
a plastic cover positioned in front of the paper-artwork strip;
at least one speaker coupled to the printed circuit board; and
a battery coupled to the device to power the device;
wherein adjacent buttons on the button membrane are spaced to correspond to products located on the shelf behind the device; and
wherein the display device delivers an audio advertisement based on a selection by a user of one of the buttons.

15. The device of claim 14, wherein the device is configured to be uncoupled from the shelf and moved to a new shelf.

16. The device of claim 14, further comprising a memory coupled to the printed circuit board.

17. The device of claim 16, wherein the memory is removable memory.

18. The device of claim 14, wherein a functionality of each of the buttons of the button membrane is programmable.

19. The device of claim 14, wherein the device is configured to gather usage statistics.

20. The device of claim 19, wherein the usage statistics include time and frequency of actuation of each button of the button membrane.
